(19) United States
(12) Patent Application Publication
(10) Pub. No.: US 2023/0149882 A1
(43) Pub. Date: May 18, 2023

(54) FLUID HANDLING DEVICE AND METHODS

(71) Applicant: THE UNIVERSITY COURT OF THE UNIVERSITY OF GLASGOW, Glasgow Strathclyde (GB)

(72) Inventor: Leroy CRONIN, Glasgow Strathclyde (GB)

(21) Appl. No.: 17/919,508

(22) PCT Filed: Apr. 19, 2021
(86) PCT No.: PCT/GB2021/050933

§ 371 Date: Oct. 17, 2022

(30) Foreign Application Priority Data
Apr. 17, 2020 (GB) 2005633.9

(51) Int. Cl. B01J 19/00

(52) U.S. Cl. CPC B01J 19/0046; B01J 19/004; B01J 2219/00389; B01J 2219/00394; B01J 2219/00686; B01J 2219/00689; B01J 2219/00695; B01J 2219/00698; B01J 2219/00722; B01J 2219/00725

(57) ABSTRACT

Provided is a fluid handling device having multiple flow pathways through the device. The device has a fluid directing manifold comprising an array of interconnected multi-directional valves, and a plurality of ports in fluid connection with the array. The device also has a controller to set the position of the multi-directional valves. The manifold is configured to provide at least two independent flow paths between a pair of ports within the manifold. Also provided is a method of using the device, and an automated chemical synthesis platform comprising the device.

### RELATED APPLICATION

The present case claims priority to, and the benefit of GB 2005633.9 filed on 17 Apr. 2020 (17.04.2020), the contents of which are hereby incorporated by reference in their entirety.

### FIELD OF THE INVENTION

The present invention relates to a fluid handling system for an automated chemical synthesis platform, a controller for the fluid handling system and a method of routing liquids through the fluid handling system.

### BACKGROUND

The automation of chemical synthesis is an ongoing technological challenge. Typically, the successful automation of synthetic procedures is limited to a few well-defined areas, such as polypeptide or oligonucleotide synthesis. Automated platforms for the synthesis of polypeptides or oligonucleotides typically comprise an array of reaction vessels (such as vials) embedded in a heating plate, along with a robotic pipetting arm which travels above the array in order to dispense reagents. Such automated systems are applicable to polypeptide or oligonucleotide synthesis because the desired target molecules can be synthesised by the successive iteration of a small palette of similar chemical reactions (e.g. amide coupling, phosphoramidite coupling). The growing peptide or oligonucleotide chains are typically immobilised on a solid support within the reaction vessels, so the robot only needs to add or remove liquid reagents from each vial and no complex synthetic operations are required. Moreover, as only a few milligrams of the target compounds are required, the pipetting system need only move small quantities of fluid.

Alternatively, the large-scale industrial synthesis of certain commodity chemicals may involve the automation of a diverse assortment of chemical reaction types. However, the large scale, commodity nature of these processes justifies the time and effort required to provide bespoke automation solutions for each synthetic step.

In contrast, the laboratory-scale synthesis of complex molecules is still a predominantly manual process, as the small-scale nature of each synthesis rarely justifies the extra effort required to automate each, often unique, reaction step. Indeed, even valuable fine chemicals such as pharmaceuticals, which are often produced in scales of up to 100 kg, are still typically produced in batch processes characterized by large number of manual handling operations.

The present inventor has previously disclosed an automated chemical synthesis platform comprising the hardware necessary to perform a diverse range of synthetic reactions

(Steiner). Known as the Chemputer, the device is able to automate batch-type synthetic procedures on laboratory scale, and it has been used to synthesise pharmaceutical compounds such as diphenylhydramine hydrochloride, rufinamide and sildenafil without any human intervention.

The Chemputer comprises a fluidic “backbone” consisting of a series of interconnected multi-directional valves arranged in a linear fashion. Each valve is associated with a corresponding pump to effect transfer of fluid through the system. This arrangement allows the transfer of material between any two ports on the backbone (see FIGS. 1 and 2).

In the Chemputer, there is a single flow path between each port on the backbone. Fluid transfer from a given source (e.g. a reagent bottle) to a given destination (e.g. a reaction vessel or analytical unit) will always occur through the same path.

This architecture gives rise to a number of downsides.

First, the movement of a component along the backbone requires the dedicated use of all the pumps and valves positioned between the source and destination. These pumps and valves cannot be used to simultaneously move another component. In practice, movement of a given component will typically require the use of a majority of the pumps and valves on the backbone so that only a single component can be moved at any one time. This increases the time needed for reagent handling. Ultimately, this increases the time required to perform a given synthesis.

Second, once a valve and pump have been used to move a component, each needs cleaning in order to avoid cross-contamination. This cleaning step also requires the dedicated use of a large number of valves and pumps, increasing down time.

Finally, the failure of a single valve prevents fluid transfer between the ports on either side of the failure, essentially partitioning the backbone. Typically, such a failure is fatal and requires the system to be shut down and the valve repaired. In extreme cases this may result in failure of the synthesis, for example if the necessary reagents are unstable or need to be added within a small time window.

A related architecture can also be found in the bespoke automated synthesis processes for large-scale commodity chemical production. Such systems typically involve dedicated pumps and supply lines for each reagent or mixture in the procedure. Although the use dedicated pumps and supply lines reduced reagent handling time and mitigates the problems of cross-contamination, failure of a pump or supply line will still result in down-time for repairs.

The present invention has been devised in light of the above considerations.

### SUMMARY OF THE INVENTION

At its most general, the present invention relates to a fluid handling device having multiple flow pathways through the device. The device uses an array of interconnected multi-directional valves to provide multiple flow paths through the device. Importantly, the path through which solutions are transported is not predetermined. Instead, a controller selects an appropriate path based on a knowledge of the system, such as knowledge of which parts are clean or dirty, and knowledge of valve failure.

By providing multiple flow paths, the device can move multiple reagents at any one time. This simultaneous movement reduces reagent handling time.

In addition, as there are multiple flow paths through the system, it is not necessary to clean the device between each reagent movement. This reduces down time. Indeed, with multiple flow paths, it is possible to clean one flow path through the device at the same time as moving reagents through a distinct flow path. This again reduces reagent handling time and down time.

Finally, the use of multiple flow paths increases failure tolerance. If a valve fails, reagents can be transported through a different flow path. This improves reliability and reduces the chance of a valve failure leading to a failure of the synthesis.

In a first aspect of the invention, there is provided a fluid handling device comprising:
(a) a fluid directing manifold comprising an array of interconnected multi-directional valves, and a plurality of ports in fluid connection with the array; and
(b) a controller to set the position of the multi-directional valves, wherein the manifold is configured to provide at least two independent flow paths between a pair of ports within the manifold.

In a second aspect of the invention, there is provided a method for controlling the fluid handling device, the method comprising:
(i) identifying the shortest flow path through the manifold; and
(ii) operating the multi-directional valves to provide the shortest flow path.

Selecting the shortest flow path through the manifold reduces reagent handling time.

In a third aspect of the invention, there is provided a method for controlling the fluid handling device, the method comprising:
(i) identifying multiple independent flow paths through the manifold; and
(ii) operating the multi-directional valves to select the multiple independent flow paths.

In a fourth aspect of the invention, there is provided an automated chemical synthesis platform comprising the fluid handling device.

These and other aspects and embodiments of the invention are described in further detail below.

### SUMMARY OF THE FIGURES

The present invention is described herein with reference to the figures listed below.

FIG. 1 illustrates a typically fluid-directing manifold (backbone) used in the known Chemputer platform. A linear arrangement of six six-way valves is shown. Each valve is represented by a circle having a single, central port and six peripheral ports. The single central port is connected to a syringe pump. The each valve is connected to the immediately adjacent valve(s) via a peripheral port. One peripheral port on each valve is connected to a waste container.

FIG. 2 illustrates the movement of a liquid across the fluid-directing manifold of the known Chemputer platform.

FIG. 3 illustrates an example of a manifold with a ring topology. Six-way valves are represented in the same way as FIG. 1, without syringe pumps or waste ports. Each valve is connected to the immediate adjacent neighbour.

FIG. 4 illustrates an example of a manifold with a full mesh topology.

FIG. 5 illustrates an example of a manifold with a partial mesh topology.

FIG. 6 illustrates an example of a manifold with a star topology. This arrangement is less preferred.

FIG. 7 illustrates an example of a manifold with a hierarchical (tree) topology. This arrangement is less preferred.

FIG. 8 illustrates an example of a manifold having two linear columns of interconnected valves.

FIG. 9 illustrates a graph representation of an example manifold. Nodes depict either locations (A, B, E, F, G), or valves (C, D, H), and the edges represent the interconnections between the valves. LEFT: shows two equivalent paths, top and bottom, to get from node E to node G. The system will randomly choose one of the two paths. MIDDLE: shows the shortest path to get from node B to node E. RIGHT: shows the connections between nodes E and C, and C and B are dirty (bold) and therefore the system chooses the lower path to get from node G to node E.

FIG. 10 provides an overview of the autonomous discovery robot used in the examples.

FIG. 11 shows the components and connections of the autonomous discovery robot used in the examples.

FIG. 12 is a schematic of the autonomous discovery robot used in the examples. A computer is connected to 13 syringe pumps and three in-line analytical instruments (ESI-MS, UV-VIS and a pH probe). The solutions are moved into five different flasks during the experiment: the premixing flask (1) where the selected starting materials are mixed; the actived copper reactor (R4) where the ligand is formed; the complex formation reactor (2) where the metal solution is added to the ligand mixture; the dilution flask (3) where samples are prepared for UV-vis and pH measurements; and the ESI-MS flask (4) where samples are prepared for the spectrometric analysis. The tubing connection between the pumps, reactors and the analytics are not displayed for clarity.

FIG. 13 shows the temperature of the cooling and heating process vs. time for the activated copper reactor (R4) used in the examples.

FIG. 14 illustrates the dilution steps for the ligand reaction A (Ald1 4.1 mL, Am2 1.2, Az4 1.0 mL, 75° C., 70 min), complex reaction B (addition of M2 1.5 mL) and a comparison of the automatically selected UV-vis spectra of both steps.

FIG. 15 illustrates the exploration algorithm operating in 2D space. The first point is chosen at random (A). The measured exploration factor, α for Point 1 determines the radius away at which Point 2 is placed (B). The larger the value of α, the smaller the radius to the next point. This stepwise exploration is continued in panels C and D. Over time, the exploration is concentrated to areas of higher chemical interest (the lighter area in the bottom left in this example).

FIG. 16 shows the MS, UV-VIS and pH data for the ligand formation reaction (Ald2 0.5mL, Am2 4.7mL. Az1 4.7mL, 60° C., 50 min) in (A). The subsequent addition of 0.8 mL of M2 causes the complex formation reaction to take place and the measurements are shown in (B).

FIG. 17 shows the crystal structures of the isolated compounds. Skeletal structures of ligands L^{1-3.}, 1, [Fe(L¹)₂](CIO₄)₂; 2, [Fe(L²)₂](CIO₄)₂; 3, [Co₂(L³)₂](ClO₄; 4, [Fe₂(L³)₂](ClO₄)₄

FIG. 18 provides ESI-MS detection of different possible structures based on the helicate complex 4 (architecture A). Architectures B and E have the general formula M₂L₃ and would be required to adopt κ²—coordination through the pyridyl and imine groups. Architectures C and D have the general formula M₂L₂, as does A, and would adopt the same κ³—coordination motif as the helicates shown in FIG. 17.

### DETAILED DESCRIPTION OF THE INVENTION

The present invention relates to a fluid handling system for an automated chemical synthesis platform, a controller for the fluid handling system and a method of routing liquids through the fluid handling system.

CN 102702304 describes a flow system for preparing nucleic acids. The system has a number of manifolds with multiway valves for controlling fluid passage through the system, together with a number of reaction vessels. However, the system in CN 102702304 cannot provide the multiple independent flow paths that are provided within the fluid handling device of the present invention. In the fluidics arrangement of CN 102702304 a reagent can seemingly only pass through the system in one way, and there is no option for a particular reagent to be provided in an alternative pathway.

From the illustrative figures in CN 102702304, it is clear that reagents are provided from reagents flasks 11 to a pre-activation device 13 for mixing and reaction (this is referred to as a deprotection step to prepare a nucleic acid for an extension reaction in the next stage). The reaction products are then delivered to a solenoid array 25, where they are combined with other reagents, delivered from different flasks 11. The combined reagents are then passed to a reaction tank 30 for further reaction, and later collection.

For any individual reagent from a specific flask 11, there is no alternative way for that reagent to be passed through the system. Thus, certain reagents can be passed to the pre-activation device 13 only, and other reagents can only be supplied to the solenoid array 25. The pre-activation device 13 can only provide a supply to the solenoid array 25, and the solenoid array can only supply the reaction tank 30.

Accordingly, the system and the methods of CN 102702304 are not directly relevant to the systems and methods of the present case.

Automated Chemical Synthesis Platform

An automated chemical synthesis platform is a robot capable of executing a chemical synthesis with limited human intervention. Automated chemical synthesis platforms are known.

The capabilities of automated chemical synthesis platforms vary widely. Typically, automated chemical synthesis platforms are specifically adapted to perform a small number of operations. For example, automated platforms for the synthesis of polypeptides or oligonucleotides typically comprises a flat bed of reaction vessels and storage vessels, along with a robotic pipetting arm which travels above the vessels. Motors control the movement of the robotic pipetting arm in the horizontal (X,Y) and vertical (Z) directions. The pipetting arm is connected to a pump that allows it to aspirate a certain volume of fluid from one reaction or reagent vessel into a pipette tip. The arm is then moved to the required position and dispenses the fluid from the pipette tip into the selected vessel. The reaction vessels are embedded in a heating plate, which allows thermocycling.

Alternative automated chemical synthesis platforms can perform a wider number of operations. These platforms may be known as general automated chemical synthesis platforms.

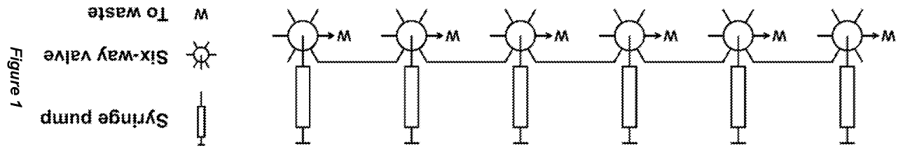

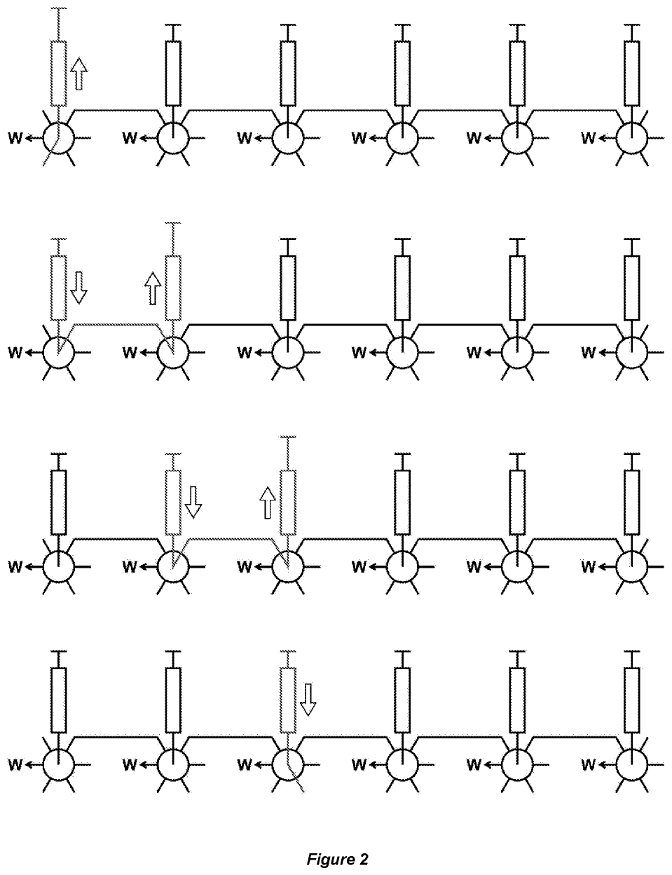

One example of a general automated chemical synthesis platform is the Chemputer, an automated chemical synthesis platform comprising different modules for performing different operations (Steiner). The Chemputer has a fluidic “backbone” consisting of a series of pumps coupled with multi-directional valves (FIG. 1). Within the backbone, the combination a valve and its associated syringe pump can be consider a single unit. To transfer fluid, the pump on a given unit (the source unit) aspirates an appropriate amount of fluid. Then, the valve on the source unit and the adjacent unit switch to form a bridge. The source pump and the adjacent pump move simultaneously to transfer the liquid contents from the source syringe to the next syringe. This process is repeated, and the liquid is moved along the backbone until it reaches the destination unit, which in turn dispenses it to the destination port (see FIG. 2).

The present invention provides a fluid handling device that is suitable for use in an automated chemical synthesis platform, including general automated chemical synthesis platforms such as the Chemputer.

Automated chemical synthesis platforms may be capable of performing reactions at a variety of scales. For example, automated platforms for the synthesis of polypeptides or oligonucleotides typically produce only a few milligrams of a target compounds. As such, the pipetting system need only move small quantities of fluid. Alternatively, the bespoke automation solutions used in large-scale industrial synthesis of commodity chemicals may produce upwards of 1000 kg of target compound and may move large quantities of fluid.

Laboratory-scale automated chemical synthesis platforms are typically configured to produce between 100 mg and 1 kg of a target compound, and move up to tens of litres of solvent. The maximum flow rate used in such systems may be 250 mL per minute, such as 200 mL per minute, 150 mL per minute or 100 mL per minute. The minimum flow rate used in such systems may be 0.1 mL per minute, such as 0.5 mL per minute or 1.0 mL per minute.

The present invention provides a fluid handling device that is suitable for use in a laboratory-scale automated chemical synthesis platform.

The present invention also provides an automated chemical synthesis platform comprising the fluid handling device.

Manifold

The fluid handling device comprises a fluid directing manifold comprising an array of interconnected multi-directional valves. The manifold comprises a series of ports for entry and exit of fluids to/from the manifold. Thus, the ports are in fluid connection with the interconnected multi-directional valves.

The array may comprise 4 or more multi-directional valves, such as 6 or more, 8 or more, 10 or more or 12 or more multi-directional valves.

The manifold allows the transport of fluids between ports through the multi-directional valves. The multi-directional valves are in fluid communication, for example the valves are connected by flow channels (pipes or tubes) to permit fluid to move through the manifold.

Typically, the manifold is configured for the transport of liquids. This includes solutions (a solute completely dissolved in a solvent), as well as slurries (a solid, for example a particulate, suspended in a liquid carrier).

The manifold is configured to provide a fluid path between each of the ports on the manifold.

In the present invention, the manifold provides at least two independent fluid paths between a pair of ports on the manifold. By providing at least two flow paths between each port on the manifold, the device can move multiple reagents at any one time. This simultaneous movement reduces reagent handling time.

Here, the flow paths are independent. Independent flow paths do no pass through the same valve.

The manifold may be described as an array or network, of interconnected multi-directional valves. Each multi-directional valve may be described as a node in the network. Similarly, each port may be described as a node in the network. An interconnection between a valve and a port, or between two valves, may be described as a link.

The topology of the manifold - that is, the arrangement of valves and flow channels - provides at least two fluid paths between each port on the manifold.

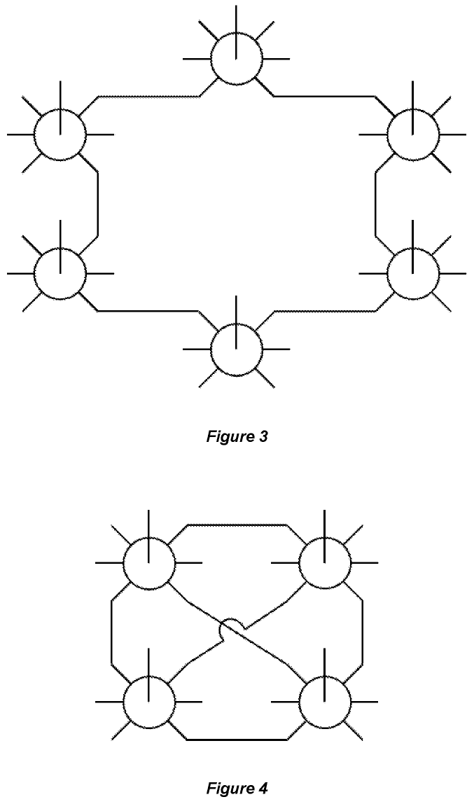

The manifold may have a ring topology. That is, each multi-directional valve in the manifold is connected to the two adjacent multi-directional valves to form a closed loop. An example of a manifold with a ring topology is shown in FIG. 3. In such cases, there are at least two flow paths between each port on the manifold, as fluid can flow in either direction around the ring.

The manifold may have a mesh topology. The mesh topology may be a full or partial mesh.

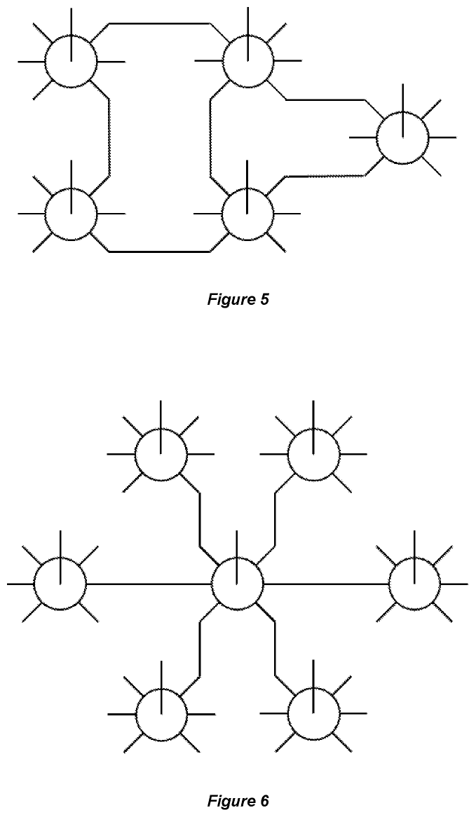

In a full mesh topology, each multi-directional valve in the manifold is a directly connected to all other multi-directional valves in the manifold. An example of a manifold with a full mesh topology is shown in FIG. 4. In such case, there are multiple flow paths between each port on the manifold.

A full mesh topology permits the simultaneous movement of reagents and so reduces reagent handling time, reduces the down time needed for cleaning and increase failure tolerance. However, the number of connections grows rapidly (quadratically) with the number of valves in the manifold. This makes the full mesh topology impractical for large manifolds. The size of the manifold is limited by the directionality of the multi-directional valves. If the directionality of the valves is 6, the full mesh topology permits a maximum of 12 ports on the manifold (using four 6-way valves).

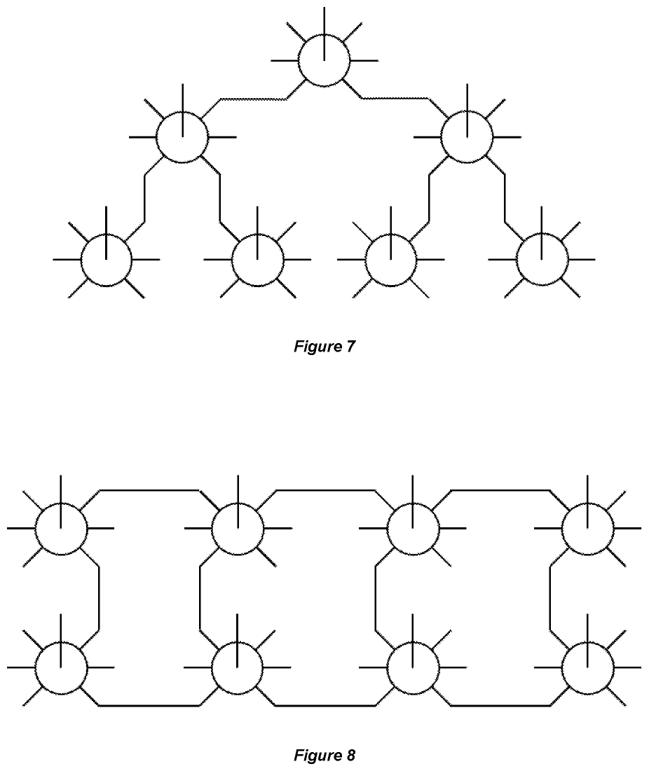

A partial mesh topology can be considered as an intermediate position between a full mesh and a ring topology. A manifold with a partial mesh topology is shown in FIG. 5. In a partial mesh topology, the number of connections between each valve in the manifold varies. Some valves may be connected to only two adjacent valves. Other valves may be connected to three or more adjacent valves. Here, it is not necessary for each multi-directional valve in the manifold to be directly connected to all other multi-directional valves in the manifold. Indeed, there may no vale within the partial mesh that is connected to all other multi-directional valves in the manifold.

A partial mesh topology typically permits the simultaneous movement of reagents through the majority of the manifold. Thus, a partial mesh topology provides the advantages of a full mesh topology and additionally the size of the manifold is not limited by the directionality of the valves. A manifold having a partial mesh topology and using 6-way valves can permit a number of ports greater than 12.

Typically, at least one of the valves in the manifold is connected to at least three other valves within the manifold. Preferably, at least two, more preferably at least three, even more preferably at least 4 and most preferably at least 5 of the multi-directional valves in the manifold are connected to at least three other valves. In the manifold shown in FIG. 5, 4 of the valves in the manifold are connect to at least three other valves.

Typically, the manifold does not have a star topology. In a star topology a central valve is connected to one or more peripheral valves. Each peripheral valve is connected to a single central valve. A manifold with a star topology is shown in FIG. 6.

Where one valve is connected to another, these valves may be physically close within the manifold, such as neighbours, such as closest neighbours. Thus, they may be adjacent. In other embodiments, one valve may be connected to another valve that is not a near neighbour, although this is less preferred.

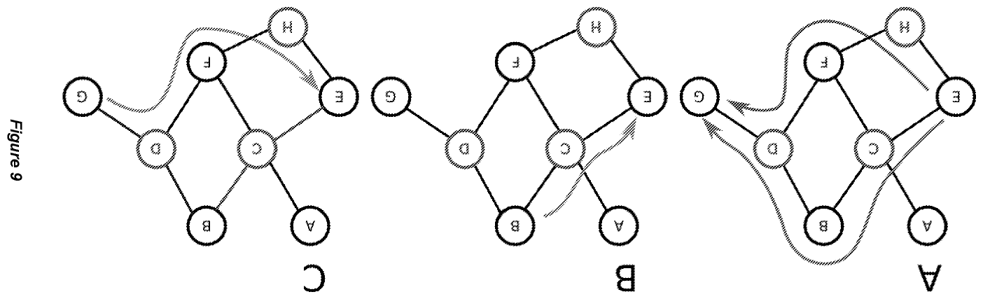

Typically, the manifold does not have a hierarchical or tree topology. In a tree topology, a parent valve is connected to one or more child valves, and each child valve may be reclusively connected to one or more grandchild valves. A manifold with a tree topology is shown in FIG. 7.

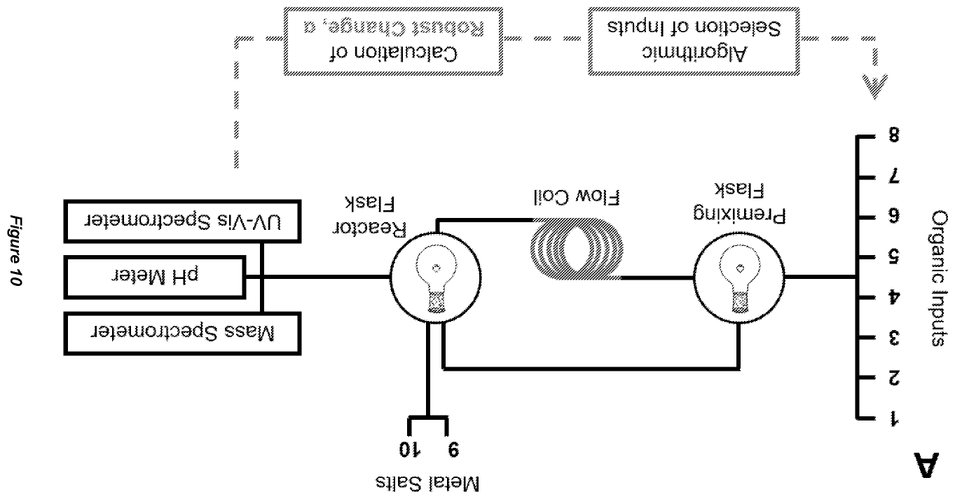

The manifold may comprise a central “backbone” or “trunk” which may be fluidly connected to one or more additional, peripheral valves. The backbone or trunk may comprise two or more linear columns of interconnected valves. By providing two or more linear columns of interconnected valves, the manifold provides at least two fluid paths between each port on the manifold. A manifold having a backbone comprising two linear columns of interconnected valves is shown in FIG. 8.

Each valve within a column may be directly connected to a corresponding valve in all columns. Alternatively, some valves in a column may only be directly connected to a corresponding valve in an adjacent column.

Peripheral valves may be connected to the manifold in any way. Peripheral valves may be connected in a hierarchical (tree) or star fashion. In such cases, there may be only one fluid path though the peripheral valves. However, this may not negatively impact reagent handling or down-time if the peripheral valves are all connected to the same reagent or waste vessels, or if the peripheral valves connect to components that are only rarely used.

Controller

The fluid handling device comprises a controller to set the position of the multi-directional valves.

The controller selects a path for movement of fluid through the manifold. That is, movement of fluid from one port to another port through the valves.

In conventional fluid handling systems, a single, predetermined route is assigned for each liquid transport operation. As such, movement of a solution from any given starting point (for example, a port) to any given end point (for example, another port) always follows the same flow path. In a conventional fluid handling system, the controller need only determine which liquid transport operation is required and select the appropriate, predetermined path for that operation.

In contrast, in the present invention, the flow path through the manifold is not predetermined. In addition, the manifold is configured to provide at least two flow paths between each port on the manifold. Therefore, the controller must select between at least two flow paths for each liquid transport operation. Typically, the controller must select between a large number, such as 100s, of flow paths for each liquid transport operation.

In the present invention, the controller selects an appropriate path based on a knowledge of the system, such as knowledge of which parts are clean or dirty, and knowledge of valve failure. The controller may also account for the length of each flow path, and an appropriate path may also be selected with knowledge of the total flow distance through the manifold.

Preferably, the manifold is represent as a graph. That is, the controller stores a graph representation of the manifold.

Different graph formats are known, such as GraphML. Graph ML is an open-standard, extensible mark-up language (XML)-based exchange format for graphs (http://graphml.graphdrawing.org [accessed 19 Oct. 2018]). The use of a graph to describe the layout of an automated chemical synthesis platform is described by (Steiner). The graph may be directed. The graph may be a bipartite graph.

Typically, in a graph representation of the manifold, valves are represented as nodes and the interconnections (flow channels) between the valves are represented as edges. A graph representation of the manifold is easily scalable as it is easy to adapt the graph to incorporate additional nodes (e.g. valves) or edges (interconnections).

The controller may use the graph representation of the manifold to select an appropriate path for transfer of liquid through the manifold. That is, the controller may selects a flow path through the manifold using the graph representation.

Typically, the controller selects the shortest path through the manifold. This reduces reagent handling time.

Methods for finding the shortest path between two nodes on a graph are known. The controller selects the shortest flow path through the manifold based on the shortest path in the graphical representation of the manifold.

Methods for finding the shortest path between two nodes in a graph include Dijkstra's algorithm, the Bellman—Ford algorithm, the A* search algorithm, the Floyd—Warshall algorithm, Johnson's algorithm and the Viterbi algorithm.

By selecting the shortest path through the manifold, the fluid handling device reduces the time needed for reagent handling.

Occasionally, there will be more than one shortest route through the manifold. Typically, this situation will arise when the fluid handling device is first used, for example, after shut down for cleaning or maintenance. The controller selects only one shortest route. Typically, the controller selects one shortest route stochastically (at random).

Typically, each valve or interconnection has attributes associated with it. These attributes may include information on its type, address and other relevant technical information. This might include information about its technical limits of operations, such as the range of flow rates under which the valve can reliably function, as well as temperature limitations, and its chemical tolerances, and chemical intolerances.

Preferably, the attributes include information on whether the valve or interconnection is clean or dirty. That is, the controller stores a state of each valve and interconnection in the manifold, where a state can be clean or dirty.

The assessment of whether a valve or interconnection is clean or dirty can be made by using sensors, such as conductivity sensors or optical sensors. Alternatively, the assessment of whether a valve or interconnection is clean or dirty can be made by considering the history (prior use) of the valve or interconnection. Typically, the assessment of whether a valve or interconnection is clean or dirty is made by considering the history of the component. Clean valves and interconnections are those which have not yet been used to move a liquid through the manifold, or that have been cleaned. Dirty valves are those which have already been used to move a liquid though the manifold and which have not yet been cleaned.

This information can be associated to the relevant parts of the graph representation of the manifold. That is, each part (node or edge) of the graph representation has attributes associated with it, and these attributes may include whether the part is clean or dirty.

The controller may select a path through the manifold using only clean valves and interconnections. As there are multiple flow paths through the system, it is not necessary to clean the device between each reagent movement. This reduces down time.

Selecting a path through the manifold using only clean valves and interconnections may be achieved by removing dirty nodes and edges from the graph representation of the manifold. That is, once a valve and/or interconnection has been used, it is marked as dirty. The corresponding nodes and/or edges are removed from the graphical representation of the manifold to produce an updated graph. The updated graph may be used by the controller when calculating the next path for movement of the next reagent through the manifold. Once the required parts of the manifold are cleaned, the corresponding nodes and/or edges may be reinstated in the graph representation of the manifold.

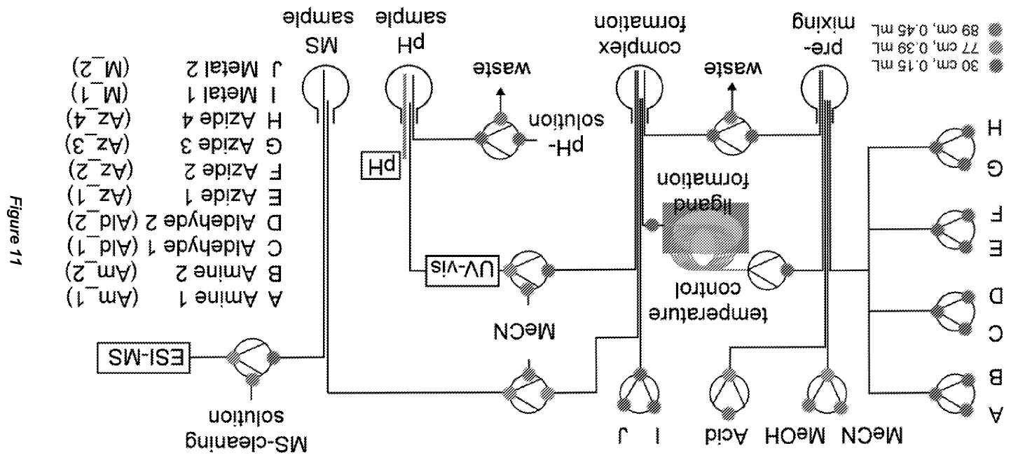

Three separate examples of path selection are shown in FIG. 9. Part A shows a case in which there are two equidistant paths to get from point E to point G. The controller selects a single path at random out of all such paths that are of the same shortest length. In this case it will have equal probability of choosing either the top or the bottom path (indicated by the top of bottom arrow). In part B there is only one shortest path between points B and E, indicated by the arrow. The controller selects this path for movement of fluid. After movement of fluid along this path, the path between B and E is dirty. This attribute is associated with each of the relevant nodes and interconnections (e.g. nodes B, C, E and their interconnections). When the system needs to move a solution from point G to point E, as described in part C of FIG. 9, it will select the path indicated by the lower arrow, since this path bypasses the dirty sections.

Preferably, the attributes include information on whether the valve or interconnection is operational or failed. That is, the controller may store a state of each valve and interconnection in the manifold, wherein a state can be operational or failed. Operational vales are those which respond to switching, and operational interconnections are those which permit fluid transfer. Failed valves are those which do not respond to switching, and failed interconnections are those that do not permit fluid transfer.

This information can also be associated to the relevant parts of the graph representation of the manifold. That is, each part (node or edge) of the graph representation has attributes associated with it, and these attributes may include whether the part is operational or failed.

The controller may select a path through the manifold using only operational valves and interconnections. As there are multiple flow paths through the system, it is not necessary to halt the synthesis if a valve or an interconnection fails. Instead, the reagents can be transported through a flow path using valves and interconnections that have not failed. This improves reliability and reduces the chance of a valve or interconnection failure leading to a failure of the synthesis.

Thus, where the controller selects the shortest path, that shortest path is the one through the manifold, taking into account failed valves and interconnections, which may close certain paths within and across the manifold.

In the same way as for the clean and dirty attributes, nodes and edges corresponding to failed valves or interconnections may be removed from the graph representation of the manifold to produce an updated graph. The updated graph may be used by the controller when calculating the next path for movement of the next reagent through the manifold. Once the required parts of the manifold are repaired, the corresponding nodes and/or edges may be reinstated in the graph representation of the manifold.

Preferably, the controller assesses the state of each valve and interconnection in real-time.

In this way, the controller can compensate for faults arising in real-time, by dynamically changing the route through which a fluid is transferred. This further increases reliability and reduces the chance of a valve or interconnection failure leading to a failure of the synthesis.

The controller may be configured to update the graphical representation of the manifold by removing nodes and/or edges having certain attributes (e.g. dirty, failed) in real time.

Similarly, the controller may be configured to update the graphical representation of the manifold by reinstating nodes and/or edges having certain attributes (e.g. clean, operational).

Preferably, the controller permits the independent movement of more than one fluid through the manifold at any given time. That is, the controller is configured to simultaneously move more than one fluid through the manifold. The solutions are simultaneously moved through independent flow paths. This simultaneous movement reduced reagent handling time.

Optionally, the controller permits the movement of both a reagent fluid and a cleaning fluid through the manifold at any given time. That is, the controller may be configured to simultaneously move a reagent fluid and a cleaning fluid through the manifold. The reagent fluid and cleaning fluid are simultaneously moved through independent flow paths. Thus, it is not necessary to clean the device between each reagent movement. This reduces down time. Moreover, it is possible to clean one flow path through the device at the same time as moving reagents through an independent flow path. This further reduces reagent handling time and down time.

Optionally, the controller permits the movement of the same fluid from the same starting or end point through independent flow paths. This reduces reagent handling time where a disproportionally large quantity of a single fluid needs to be moved. For example, where a large quantity of solvent needs to be moved, or where a large quantity of material needs to be discharged to waste.

The controller can set the position of each of the multi-directional valves within the manifold. This allows the controller to select the path for movement of fluid through the manifold. Optionally, the controller can control other aspects of the system. For example, the controller may control pumps in order to affect reagent movement through the manifold. Similarly, the controller may set the position of peripheral valves connected to the manifold in order to affect reagent movement through peripheral devices connected to the manifold. Examples of such peripheral devices include storage units (e.g. reagent vessels, solvent vessels and waste vessels), reactors, purification devices (filtration, liquid-liquid extraction, chromatography and rotary evaporators) and analytical units (e.g. liquid or gas chromatography, NMR, IR, UV-VIS or mass spectrometry).

Components

The fluid handling device comprises a plurality of interconnected multi-directional valves. The multi-directional valve has multiple positions and is capable of forming a fluid path between any two valve positions. These valves may be known as selection valves.

The multi-directional valve may have three or more valve positions, such as four or more, five or more, six or more, seven or more or eight or more. Typically, the multi-directional valve comprises six valve positions (a six-way valve). Six-way valves are available from commercial sources, for example, the six-way selection valve from IDEX Health & Science

The interconnections between the valves provide a flow path between the valves for movement of fluid. These interconnections may be referred to as fluid channels. Typically, an interconnection has channel walls comprising a chemically-resistant material, such as a solvent-resistant material. Typically, the interconnections comprise PTFE. PTFE tubing is commercially available and commonly used in chemical techniques, such as flow synthesis.

The fluid handling device permits the movement between the ports on the manifold. Typically, the movement of fluid is provided by mechanical pumps. Typically, the pumps are positive displacement pumps. Examples of positive displacement pumps include peristaltic pumps and syringe pumps. Preferably, syringe pumps are used.

Fluid flow, such as liquid flow, may also be provided by gravity feed.

The fluid handling device may be connected to additional peripheral devices. Peripheral devices may include devices adapted for performing synthetic operations. Examples of such peripheral devices include devices for filtration, liquid-liquid extraction, chromatographic separation, evaporation, and heating under reflux at controlled pressure, as well as reaction vessels.

A peripheral device may be a storage vessel, such as a reagent vessel, solvent vessel or a waste vessel.

Peripheral devices may also induce devices adapted for analytical measurement. Examples of such peripheral analytical devices include for pH measurement (e.g. conductivity sensors), colour change measurement (e.g. cameras), UV-VIS spectroscopy, IR spectroscopy, NMR spectroscopy, mass spectroscopy, liquid chromatography and gas chromatography.

Methods

The invention provides a method for controlling the fluid handling device described herein, the method comprising:
(i) identifying the shortest flow path through the manifold of the fluid handling device; and
(ii) operating the multi-directional valves to select the shortest flow path.

If there is more than one shortest flow path through the manifold, the method may comprise randomly selecting one of the shortest flow paths.

As noted above, the multi-directional valves and interconnections may have associated attributes, such as information on whether the valve or interconnection is clean or dirty. Therefore, the method may comprise assessing a state of each valve and interconnection in the manifold, wherein a state can be clean or dirty.

The assessment of whether a valve or interconnection is clean or dirty can be made by using sensors, such as conductivity sensors or optical sensors. Alternatively, the assessment of whether a valve or interconnection is clean or dirty can be made by considering the history of the valve or interconnection. Typically, the assessment of whether a valve or interconnection is clean or dirty is made by considering the history of the component.

The method may comprise identifying a flow path through the manifold using only clean valves and interconnections. As there are multiple flow paths through the system, it is not necessary to clean the device between each reagent movement. This reduces down time.

Preferably, the attributes include information on whether the valve or interconnection is operational or failed. Therefore, the method may comprise assessing a state of each valve and interconnection in the manifold, wherein a state can be operational or failed.

The method may comprise identifying a flow path through the manifold using only operational valves and interconnections. As there are multiple flow paths through the system, it is not necessary to halt the synthesis if a valve or interconnection fails. Instead, the reagents can be transported through a different flow path. This improved reliability and reduces the chance of a valve or interconnection failure leading to a failure of the synthesis.

Preferably, the method comprises assessing the state of each valve and interconnection in real-time. In this way, the method can compensate for faults arising in real-time, by dynamically changing the route through which a fluid is transferred. This further increases reliability and reduces the chance of a valve or interconnection failure leading to a failure of the synthesis.

Preferably, the manifold is represented as a graph. That is, the the method comprises providing a graph representation of the manifold. As noted above, in a typical graph representation of the manifold, valves are represented as nodes and the interconnections (flow channels) between the valves are represented as edges.

The method uses the graph representation of the manifold to select an appropriate path for transfer of liquid through the manifold. For example, the method may comprise identifying the shortest path between two nodes in the graph representation and operating the valves to correspond to the shortest path in the graph representation. As noted above, methods for finding the shortest path between two nodes on a graph are known.

As noted above, methods for finding the shortest path between two nodes on a graph are known. Such methods include Dijkstra's algorithm, the Bellman—Ford algorithm, the A* search algorithm, the Floyd—Warshall algorithm, Johnson's algorithm and the Viterbi algorithm.

As noted above, attributes may be associated with each part of the graph (node or edge), and these attributes may include information on whether the part is clean or dirty. In such cases, the method may use the graph representation of the manifold to identify a flow path through the manifold using only clean valves and interconnections

Similarly, the attributes may include information on whether the part is operational or failed. In such cases, the method may use the graph representation of the manifold to identify a flow path through the manifold using only operational valves and interconnections

The method may comprise updating the graphical representation of the manifold by removing nodes and/or edges having certain attributes (e.g. dirty, failed) in real time. Similarly, the controller may be configured to update the graphical representation of the manifold by reinstating nodes and/or edges having certain attributes (e.g. clean, operational).

Optionally, the method permits simultaneous independent movement of more than one fluid through the manifold. That is, the method comprises simultaneously identifying more than one flow path through the manifold, and operating the multi-directional valves to correspond to each flow path. Thus, it is not necessary to clean the device between each reagent movement. This reduces down time.

The use of multiple independent flow paths through the manifold allows for maximum utilisation of the flow lines and the multi-directional valves within the manifold.

Where the method involves the use of multiple independent flow paths through the manifold it is not necessary for one, or each, of these flow paths to have the shortest flow path through the manifold. However, the system may operate such that, together, the flow paths are selected to have the shortest possible paths through the manifold.

Accordingly, the invention also provides a method for controlling the fluid handling device, the method comprising:
(i) identifying multiple independent flow paths through the manifold; and
(ii) operating the multi-directional valves to select the multiple independent flow paths.

Moreover, it is possible to clean one flow path through the device at the same time as moving reagents through an independent flow path. That is, the flow path may comprise one flow path for movement of a reagent fluid through the manifold, and one flow path for movement of a cleaning fluid through the manifold. There is no fluid interconnection between these flow paths: here, the setting of the valves prevents contact between these flow paths. This further reduces reagent handling time and down time.

Optionally, the methods of the invention may comprise operating pumps, such as positive displacement pumps, to provide movement of a fluid through the flow path.

Computer Program

The invention also provides computer-implemented methods and computer programs for controlling the fluid handling device.

The invention provides a computer-implemented method for controlling the fluid handling device described herein, the method comprising the steps of:
(i) providing a graph representation of the manifold within the fluid handling device, in which graph representation nodes represent valves and edges represent interconnections;
(ii) identifying the shortest path between two nodes in the graph representation; and
(iii) outputting an operation list comprising instructions for operating the multi-directional valves to correspond to the shortest path.

Methods for finding the shortest path through the graphical representation are known and are discussed above.

As noted above, the multi-directional valves and interconnections may have states, such as information on whether the valve or interconnection is clean or dirty, and this information can be associated to the relevant parts of the graph representation of the manifold. In such cases, the method may comprise assessing the attributes of each node and edge in the graph representation, where an attribute can be clean or dirty, and identifying a path through the graph representation using only clean nodes and edges.

Similarly, the attributes may include information on whether the valve or interconnection is operational or failed. In such cases, the method may comprise assessing the attributes of each node and edge in the graph representation, where an attribute can be operational or failed, and identifying a path through the graph representation using only operational nodes and edges.

The invention also provides a data processing device comprising:
(a) means for providing a graph representation of a manifold within a fluid handling device of the invention;
(ii) means for identifying the shortest path between two nodes in the graph representation; and
(iii) means for outputting an operation list comprising instructions for operating the multi-directional valves to correspond to the shortest path.

The invention also provides a computer program comprising instructions which, when the program is executed on a computer, cause the computer to carry out the steps of:
(i) providing a graph representation of a manifold within a fluid handling device of the invention, in which graph representation nodes represent valves and edges represent interconnections;
(ii) identifying the shortest path between two nodes in the graph representation; and
(iii) outputting an operation list comprising instructions for operating the multi-directional valves to correspond to the shortest path.

The invention also provides a computer-readable storage medium comprising instructions which, when executed by computer, cause the computer to carry out the steps of:
(i) providing a graph representation of a manifold within a fluid handling device of the invention, in which graph representation nodes represent valves and edges represent interconnections;
(ii) identifying the shortest path between two nodes in the graph representation; and
(iii) outputting an operation list comprising instructions for operating the multi-directional valves to correspond to the shortest path.

That is, the invention also provides a computer-readable storage medium having stored thereon any computer program disclosed herein.

The computer-implemented methods and computer programs for controlling the fluid handling device may be used to control the manifold within the fluid handling device to allow for the operation of multiple independent flow paths through the manifold.

As noted above, the methods of the invention permit simultaneous independent movement of more than one fluid through the manifold. The computer program for controlling the fluid handling device may identify more than one flow path through the manifold, and it may operate the multi-directional valves to correspond to each flow path. Each flow path is independent of another flow path.

The computer program can output instructions for operating the multi-directional valves to correspond to the more than one flow paths through the manifold. The operation of the manifold according to these instructions allows the system to maximise its use of the physical hardware within the fluid handling device.

A computer program for controlling the timing and routing of multiple flows through the manifold may be referred to as a scheduler.

The scheduler may also be programmed to allow for changes in the flow paths—re-routing—to allow for cleaning operations, for example to remove contaminants and to clear blockages in flow lines and multi-directional valves. Thus, the scheduler is adaptive, and allows for the intelligent selection of flow paths according to the circumstances and requirements of the system and the user.

Where a synthesis programme requires a system to undertake multiple flow reactions, the scheduler may be suitably programmed to schedule those flow reactions to maximise utilisation of the multi-directional valves and the flow lines within the manifold. Here, the scheduler can minimise the total reaction time required for the complete reaction set.

Other Embodiments

Each and every compatible combination of the embodiments described above is explicitly disclosed herein, as if each and every combination was individually and explicitly recited. Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

Experimental

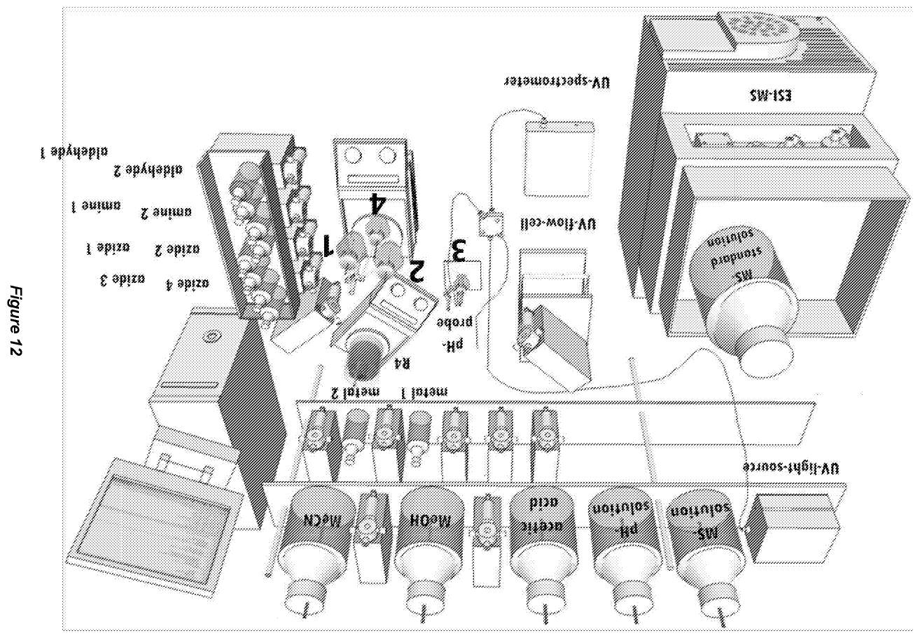

The fluid handling device of the present invention was use as part of an automated chemical synthesis platform for the synthesis and analysis of supramolecular complexes. A closed-loop system was devised and was capable of synthesising a ligand, performing the organometallic complexation reaction, analysing the reaction output and then make decision on the next reaction to perform in order to explore the reaction space. An overview of this system is shown in FIG. 10.

The autonomous decision making in this system focuses on the exploration of the most interesting regions of the chemical space by using live experimental data of reaction mixtures. For a robust definition of interest, the system measures the change that has occurred during a reaction. The chemical space is defined by a selection of the starting materials consisting of the potential ligand building blocks and transition metal ions, and by three different reaction parameters: i) reagent volumes; ii) reaction temperature; and iii) reaction duration.

A previously unknown ligand system for exploration and coordination motif was selected for exploration with the robot (see Scheme 1). The synthesis was carried out as a three-component reaction by combining one pyridinecarboxaldehyde (from two possibilities), one aminoalkyne (from a set of two) and one azide (from set of four), each with a selected volume, for a chosen duration and temperature. The full set of choices results in 394 million possible reactions, demonstrating that even a limited number of inputs defines a vast number of potential experiments.

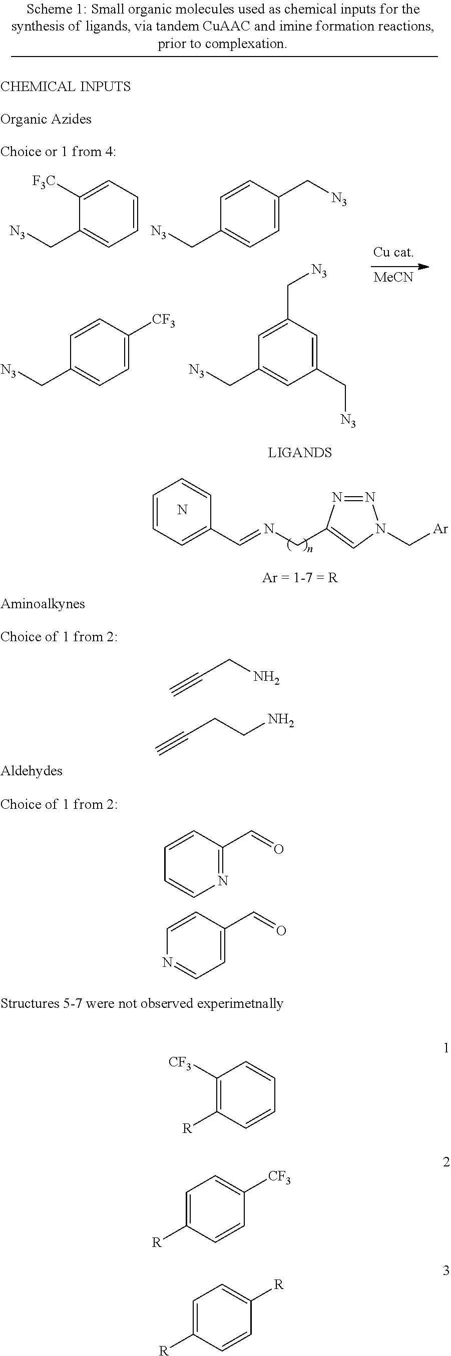

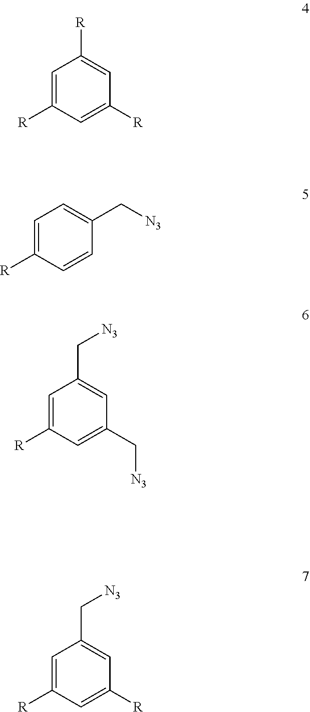

The reactor for the synthesis step consists of a catalytically active 10 mL capacity copper coil, which allows for the synthesis of the bespoke ligand system within a short duration of under 2 h (ligand dependent). This activated reactor promotes the coordination of the in situ formed ligand with leached Cu. The ligand formation happens due to full or partial imine condensation and/or copper-catalysed alkyne-azide cycloaddition (CuAAC), depending on the reaction temperature and reaction duration.

The experimental space is seven dimensional as it is defined by the reagents chosen (one aldehyde, one amine, one azide and one metal), the reagent volumes used (from 0.5 mL to 5 mL each), the reaction duration (from 5 to 120 min) and temperature (from 30 to 80° C.). The different possible combinations of ligand precursors can make 56 potential ligands, see Scheme 1. The metal-exchange reaction occurs once the ligand mixture collected from the catalytically active reactor (without purification) undergoes a second reaction step, consisting of complexation with a chosen volume of one of two metal salt solutions—[Fe^{∥}(ClO₄)₂] or [Co^{∥}(ClO₄)₂]. Including the second coordination step, the number of possible experiments in the chemical system increases to 4×10¹⁴. The cleaning, reaction activation and decision-making operations are all fully automated, allowing the continuous operation of the system without human involvement.

Materials

All chemicals were supplied by Fisher Chemicals, Sigma Aldrich and Lancaster Chemicals Ltd. and were used without further purification. Solutions were freshly prepared before each experiment. Solvents for synthesis (AR grade) were supplied by Fisher Chemicals and Riedel-de Haen. Deuterated solvents were obtained from Goss Scientific Instruments Ltd. and Cambridge Isotope Laboratories Inc. PTFE tubing with different internal diameters, PEEK connectors and manifolds were supplied by Kinesis (Kinesis Ltd.). Copper tubing was supplied by RESTEK.

Equipment

Computer controlled hot plate: IKA RET control. Integrated temperature control enables connection of a temperature probe, placed directly in the medium, to control its temperature with a high degree of precision. PT 100 temperature sensor was used. The stainless steel composite hot plate, reaching a temperature of 340° C., enables rapid heating. RS 232 interface enable PC control of the magnetic stirrer, heating function and recording of all current parameters. A locking function prevents inadvertent changes of speed and temperature settings.

Syringe pumps: Liquid handling was performed using C3000 model, TriContinent™ pumps (Tricontinent Ltd, Calif., USA) equipped with 5 mL syringes (TriContinent™) and 3-way solenoid valves (TriContinent™). Pump accuracy tests/results are reported in Table 1 and were carried out with water.

TABLE 1
Tricontinent syringe pump accuracy
test with average error percentage

| Set value | Measured | Individual | Average ± |
|---|---|---|---|
| (mL) | value (mg) | error (%) | error (%) |
| 0.01 | 0.0059 | 41.0 | 40.5 ± 3.5 |
| | 0.0056 | 44.0 | |
| | 0.0063 | 37.0 | |
| 0.05 | 0.0423 | 15.4 | 15.2 ± 0.4 |
| | 0.0426 | 14.8 | |
| | 0.0422 | 15.6 | |
| 0.1 | 0.0913 | 8.7 | 8.15 ± 0.55 |
| | 0.0924 | 7.6 | |
| | 0.0922 | 7.8 | |
| 0.25 | 0.2417 | 3.32 | 2.96 ± 0.36 |
| | 0.2435 | 2.6 | |
| | 0.2434 | 2.64 | |
| 0.50 | 0.4938 | 1.24 | 1.46 ± 0.22 |
| | 0.4916 | 1.68 | |
| | 0.5081 | 1.62 | |
| 1.00 | 0.9927 | 0.73 | 0.665 ± 0.065 |
| | 0.9940 | 0.60 | |

In-Line Analytics

Bench-top MS spectrometry: The spectra were recorded using a Microsaic systems 4000 MiD, spraychip® (electrospray ionization source). ^{Masscape}® software was used for control of sampling methods and manual data analysis. The specifications of this spectrometer are listed below:

| | |
|---|---|
| Mass analyzer | ionchip ® quadrupole mass spectrometer |
| Direct flow rate | 0.2 μL min⁻¹-2 μL min⁻¹ |
| Split flow rate | up to 2.0 mL min⁻¹ |
| Make-up flow | 1 mL min⁻¹, 50:50 MeOH:H₂O |
| Attenuation | 1000 |
| Ionisation mode | positive |
| Tip voltage | 850 V |
| Nebulizer (N₂) flow | 2.5 L min⁻¹ |
| Vacuum interface voltage | 40 V |
| Tube lens voltage | 10 V |
| Plate lens voltage | 5 V |
| Ion guide voltage | 1 V |
| Count time | 0.20 ms |
| Mass range | m/z 50-800 with ionchip ®150 |
| Mass accuracy | +/−m/z 0.3 in full scan |
| Mass resolution | m/z 0.7 +/− 0.1 FWHM |

UV-Vis spectroscopy: UV-vis spectra were acquired with a DH-2000 light source and a flow cell FIA-Z-SMA 905 (10 mm path length) from Ocean Optics, connected by fiber optics to an AvaSpec 2048 from Avantes. Spectra were collected every 1-2 seconds employing a customized program and processed employing an in-house developed program with Python and LabVlEW™.

pH meter: VWR universal pH and redox electrode supplied with a durable epoxy body shaft sealed gel-filled reference designs. This is also supplied with ceramic diaphragm and fixed cable. Diameter and length are 12 mm and 120 mm respectively.

Hardware Set-Up

All liquid handling was undertaken by TriContinent™ pumps equipped with 5 mL syringes and 3-way solenoid valves. All syringe pumps were equipped with PTFE tubing for delivering the reagents into the reactors and moving the solutions in the system. All in line analytics were physically connected to a computer by a USB to a daisy chained serial connection. Schematics of the chemical robot are illustrated in FIGS. 11 and 12, with specifications shown in Table 2.

TABLE 2
Hardware parameters

| | |
|---|---|
| Number of pumps | 13 |
| Volume of the syringes | 5 mL |
| Number of chambers | 5 (pre-mixing, ligand formation, complex |
| | formation, pH sample, MS sample) |
| Reactor volume | Ligand formation: 10.0 mL copper coil |
| | Pre-mixing, complex formation: 10.0 mL RBF |
| | pH sample, MS sample: 5 mL RBF |
| Reactor type | Ligand formation: ⅛ inch outer diameter |
| | copper tubing with an internal diameter of |
| | 1.6 mm and a tube length of 4.97 m |
| | Pre-mixing, complex formation, pH sample, |
| | MS sample: round bottom flasks |
| Connectors | Standard connectors made of FPM and PEEK |
| | equipped with check valves (made of PEEK |
| | with a Chemraz ® O-ring, which is compatible |
| | with organicsolvents and compounds) |
| In-line analysis | ESI-MS, UV-vis, pH |
| Control | Alpha-Jump Exploration Algorithm (python, |
| | written bespoke for this project) |

Five syringe pumps (5 mL) are connected to the ten possible reagent inputs (A-J, FIG. 11) in the system, whilst the remaining eight 5 mL syringe pumps are used to move solvents and reaction mixtures between the reactors or the analytics. In particular, the organic reagents selected for the experiment are initially combined in the premixing reactor (1 in FIG. 12) before being delivered to the activated flow reactor (R4 in FIG. 12), which is positioned on a computer-controlled hot-plate. The reaction solution from the activated flow reactor is transferred into a collection reactor (2 in FIG. 12) where the solution can be sent to the analytical instruments or reacted with the metal salt solutions (I-J, FIG. 11). The samples sent for pH-measurements pass through the UV-flow cell, at which time a measurement of the UV-vis spectrum is taken, before samples reach the dilution flask (3 in FIG. 12). The sample solution is then disposed by direct transfer to the waste bottle. The samples sent for MS measurements are first placed in the corresponding MS preparation vial (4 in FIG. 12) before transferring to the spectrometer. The sample analyzed by MS is also transferred directly to waste. The MS line is then cleaned using a solution of MeCN and H₂O as a 1/1 (v/v) mixture with 1% formic acid. One pump is associated with pure acetic acid, used for the activation of the flow reactor, whilst a second is linked to MeCN and MeOH used for the cleaning procedure before running a new experiment.

The chemical robot is intrinsically dependent on the connectivity of the liquid-handling system with the reagents and the other components of the system. A configuration file with the overall connectivity allows our system to understand the layout and autonomously direct the experiments.

Robot Operation

Once the experiment is chosen, the system is programmed to prime the syringe pumps, set the hot plate temperature, and collect the UV-vis spectrum of the solvent to be used as a reference. Once the system has reached the selected reaction temperature, all reagents are mixed in the pre-mixing reactor before transferring 10 mL of the solution into the chemical reactor at the selected temperature. If the total volume in the premixing vial is smaller than the volume of the copper coil reactor, MeCN will be added to reach 10 mL. If the total volume is greater than 10 mL any excess is directed to waste. After waiting for the stochastically selected reaction time, the reaction mixture is transferred from the activated flow reactor to the complexation reactor.

At this point the reaction mixture is analyzed. 1 mL of reaction mixture is moved from the complex formation to the MS preparation . From this , the sample is delivered to the benchtop MS using a dedicated syringe pump. 1.35 mL of reaction mixture is also separately sampled from the complex formation to the UV-vis flow cell, from where it is then directed to the dilution containing the pH probe.

The selected metal salt solution is then combined with the ligand mixture in the complex formation , giving an immediate noticeable colour change. At this point an e-mail is sent to the operator to indicate that the complexation step is completed and the reaction solution can be physically collected if so desired (e.g. for crystallization). This pause in the procedure can also be bypassed if the operator decides to either not collect the samples or if the user is in the proximity of the system. After collecting the sample, the system cleans all parts of the robots which have been in contact with reagents and reaction mixtures, including the plunger/syringe of the pump which potentially can choose between two different reagents, in order to limit contamination issues. At the same time, the chemical robot also autonomously calculates a for the selection of the next experiment, in order to start the preparation step (as previously described) as soon as the cleaning cycle is completed. If the value of a is below an arbitrary threshold the system will email the operator and notify them of a possible point of interest.

Temperature, Cross-Contamination and Reactor-Activation Control

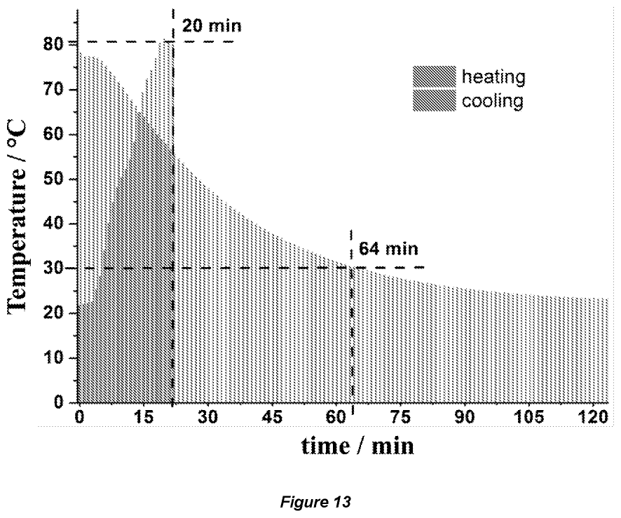

The temperature can be changed from one experiment to another without the need for intervention as the hot plate in the system is computer-controlled. In order to better synchronize all chemical robot operations and have an estimation of each experiment duration (including waiting time), the time necessary to switch between temperatures was measured, as illustrated in FIG. 13. The test was done in the temperature range of 30-80° C. (y axis). It was found that when heating from 30° C. to 80° C. (red bars), less than 20 min were required. However, cooling from 80° C. to 30° C. (blue bars) took more than one hour. To overcome the worst case scenario, cooling from 80° C. to 30° C. between one experiment and next, the system was programmed to set the temperature for the next experiment as soon as the previous experiment is finished and before the cleaning procedure. The cleaning procedure takes 100 min during which all reactors, pumps and equipment are cleaned, and the copper tubing is activated. The cleaning of the tubing connected with the MS and the MS itself are also performed using a mixture of MeCN:H₂O (1:1, v:v) with 1% (v/v) of formic acid. The cleaning/activation procedure for the copper reactor consists of flushing the copper coil with different solvents. In particular, the flow reactor is flushed with 10 mL of MeOH, before being filled with pure acetic acid. After 10 min, the flow reactor is flushed with 10 mL of acetic acid first and afterwards with 20 mL of MeOH.

The flow reactor is filled with 10 mL of MeOH. After 10 min, the flow reactor is flushed with 20 mL of MeOH first and afterwards with 20 mL of MeCN. The flow reactor is then filled with 10 mL of MeCN. After 5 min, the flow reactor is flushed with 50 mL of MeCN, before starting the next chosen reaction.

Automated Acquisition of UV-VIS Data

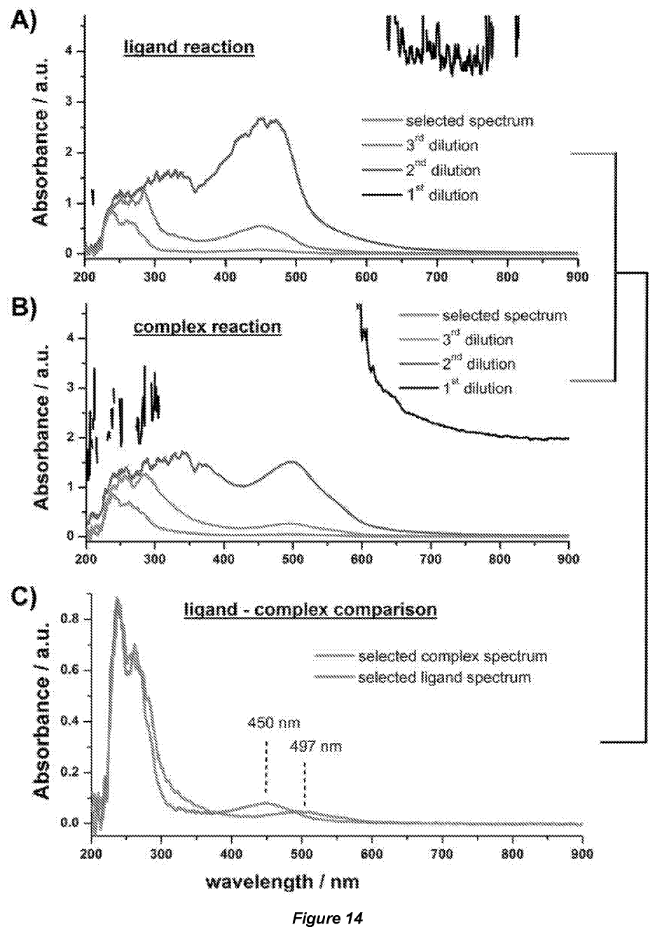

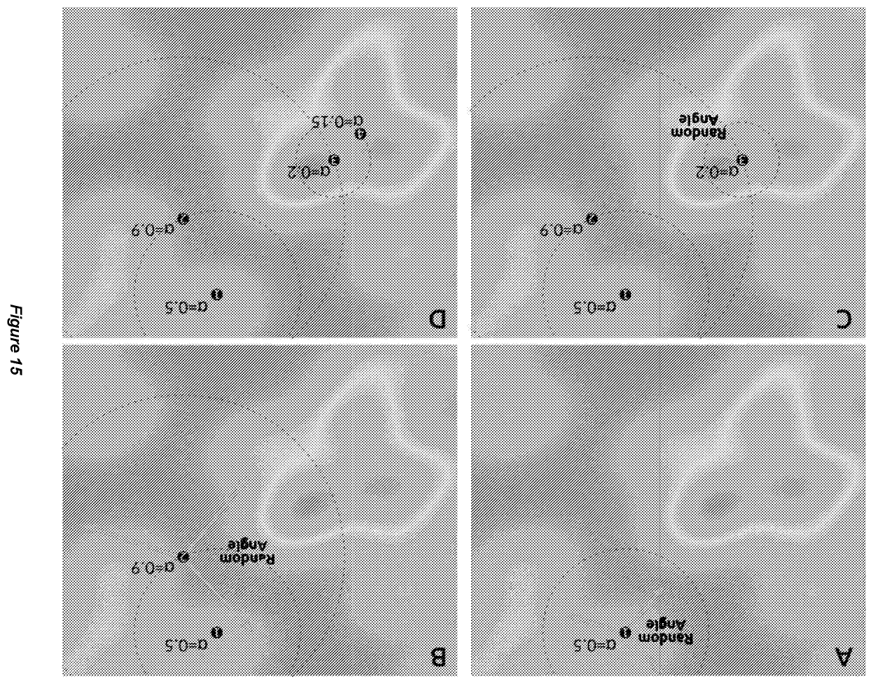

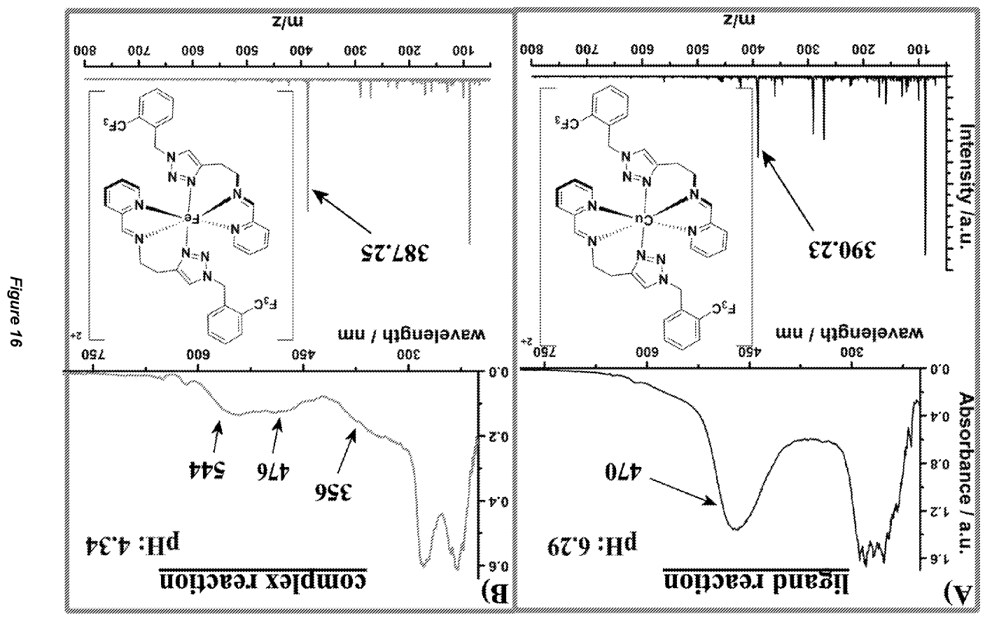

The samples were diluted in order to have conclusive data that could be reliably processed by the chemical robot. The dilution step for both ligand and complex reaction mixtures was programmed to be performed in the syringe of a dedicated syringe pump. This pump was programmed to sample 1 mL of the reaction mixture to the UV-Vis flow cell. After this first measurement, if the spectrum is saturated, another 0.35 mL of the reaction solution is withdrawn by the pump and mixed internally with MeCN to achieve a 1:10 dilution ratio. 0.35 mL of this diluted reaction mixture remains in the syringe, the rest is transferred to the UV-vis flow cell and the new spectrum is acquired. This dilution operation is repeated as needed on the remaining 0.35 mL until the measured spectrum has a maximum absorbance band smaller than 1 a.u. (FIG. 14).

Automated Acquisition of pH-Values

A sample of reaction mixture in MeCN is mixed with an excess of MeCN:H₂O 1:1 (v/v), referred to as pH_solution before the measurements. A suitable cleaning procedure for the probe comprises checking the pH_solution value after each measurement. 0.25 mL of the reaction solution was diluted with 3 mL of pH_solution, so the liquid covers the active region of the probe. A change in the pH values among the different classes of starting materials was clearly observed. In particular the pH range of aldehyde is 4-5, of amines is 8-9, of azides is 6-7 and of metals is 2-4.

Exploration of Chemical Space

The exploration algorithm was designed to not rely on any knowledge beyond the initial choice of the ligand and reaction conditions. The explored areas may or may not contain discoveries, but the algorithm was designed to focus exploration of all regions. The algorithm does not build a model of the space during its exploration through it. Rather, the system is designed to search in a stochastic manner, avoiding bias or heuristics, to find areas of interest. Rather than optimize the reactivity, the system is designed to find as many interesting points in the chemical space.

To be able to evaluate each experiment as a data point in the chemical space, the algorithm uses a live data stream from three sensors (UV/Ms, mass spectrometry and pH) to construct a simple and robust measure of the change occurring over both ligand synthesis step, and the metal ion coordination step (see ESI). Therefore, the autonomous exploration of the chemical space is driven by the degree of change from the starting materials to the ligand and between the ligand and the coordination complex. This is characterized by an exploration factor, a, which is inversely proportional to the amount of change calculated which in turn is related to reactivity or the degree to which a reaction has occurred. For a low a case the exploration algorithm will result in the next experiment being close in parameter space to the previous one, as this indicates a region of high reactivity. Conversely, if the change was small (i.e. high a and low reactivity) the system will search further away, in order to actively seek areas with more change. It is possible for the system to get stuck, so if too many experiments are performed in a small region, the system is programmed to jump to an unexplored part of the experimental space far away. In this way the algorithm is designed to perform a minimum number of experiments in any given area of interest to maximize the space explored.

An explanation of the principles of operation of the exploration algorithm is shown in FIG. 14, which shows an illustration of the algorithm exploring a 2D space with colour representing the low change areas (dark) to high (light). The first experiment in the sequence is a random point yielding a moderate value of difference change leading to a corresponding value of α₁, where α is the radius of a circle around the point. The next experiments selected by the algorithm are points in the parameter space on this circle line, with the choice of point two (B) from these being stochastic, as the algorithm knows nothing about the space. The new experiment will become the centre of the new circle having a well-defined radius of α₂, and so on (panels C and D). It is important to note that the system is programmed to have no more than three consecutive experiments in the same region of space, in order to avoid exploring the same local area in a loop.

The calculation of a is based on the ratio of differences between the analytical measurements of the ligand with its starting materials, and between the ligand and its resulting complex.

Thus, this value constrains the exploration range for the next randomly chosen experiment. In general, the differences are all based on the comparison of the two data sets—the ligand mixture and starting materials; or complex combination and ligand mixture. Specifically, MS changes are calculated using the most intense and highest m/z peaks found in each of the two spectra compared; UV-vis changes are measured as the difference of the two spectra compared after normalization by calculating the root mean square value of the peak area difference; pH changes are evaluated using the pH of the starting material or of the ligand as a reference value.

FIG. 16 shows the analytical output from the set of three instruments on the same experiment.

Results

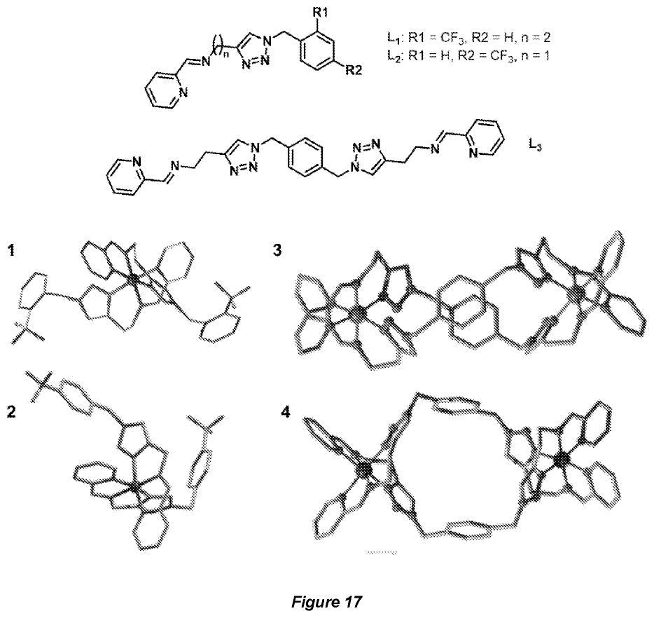

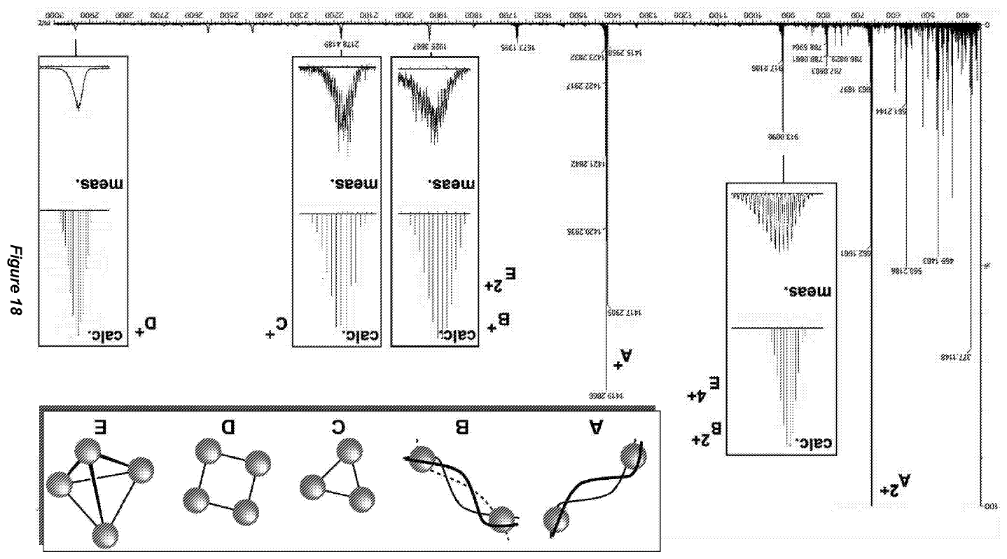

The system was able to autonomously synthesise a range of 1-benzyl-(1,2,3-triazol-4-yl)-N-alkyl-(2-pyridinemethanimine) ligands which were then applied in the discovery of new complexes: [Fe(L¹)_{2]}(CIO₄)₂(1); [Fe(L²)^{2]}(CIO₄)₂ (2); [Co₂(L³)_{2]}(CIO₄)₄ (3); [Fe₂(L³)₂](CIO₄)₄ (₄). (4). The crystal structures of (1) to (4) and the skeletal structures of ligands L1-3; 1, are shown in FIG. 17.

Complex 1 is formed through tridentate coordination of each ligand to Fe(II), with one N-donor atom from each of the pyridine, imine, and triazole groups. Despite L¹ being more flexible than L² (due to the additional methylene group), the favored coordination mode is still tridentate with all nitrogen containing moieties bound. In the UV-vis spectrum of the complex mixture (FIG. 13), three new absorbance bands are detected at 356, 476 and 544 nm. This evidence lets us conclude that the intermediate [Cu(L¹)₂]²⁺ formed in the flow reactor undergoes a metal exchange process in the presence of the Fe(II) salt to give [Fe(L¹)2](CIO₄)₂. Also, the pH values and the ESI-MS spectra of the two analyzed mixtures are in accordance with this observation. In fact, a significant change in the acidity of the new complex from 6.29 to 4.34 is detected. The ESI-MS shows the presence of peaks with m/z of 390.23 in the ligand mixture and m/z of 387.25 in the complex mixture. These could be assigned to [Cu(L¹)₂]²⁺ and 1 respectively.

Using this same methodology [Fe(L²)₂](CIO₄)₂ (2) was discovered from an alternate set of input reagents yielding the general ligand framework 1-benzyl-(1,2,3-triazol-4-yl)-N-alkyl-(2-pyridinemethanimine). Further exploration of the space led to the isolation of helicates [Co₂(L³)_{2]}(CIO₄)₄ (3) and [Fe₂(L³)_{2]}(CIO₄)₄ (4) forming an M₂L₂ cage using a ligand based on a structure 3 type motif.

The autonomous analytics run on these reaction mixtures show that this way of conducting experiments can generate a huge variety of different complexes in solution, not only because of the range of potential coordination modes of the ligands, but especially because more than one ligand can be present in the reaction solution and reactions may be performed with non-standard reagent stoichiometries. This is demonstrated by the fact that we could isolate compound 4 through crystallization from the reaction solution but the ESI-MS measurements of the reaction mixture reveals more species to be present in solution, see FIG. 18.

All the assumed adducts are also summarized in FIG. 18 and one set of signals for the compound indicated as A are consistent with the assumption that the tridentate motif coordinates two times per metal center to form the isolated helicate 4. Changing the coordination mode can allow the formation of a triple stranded helicate (B) or a cage like arrangement (E). However, other peaks have m/z values that can be associated with the mass of specific cages, such as circular triangular (C) or square (D) arrangements. Arrangements like C and D may be possible because of the flexibility of ligand L³. However, to obtain those structures the conformation of the ligand (especially for the tridentate motif) must change to a bidentate motif. This makes it possible that three bidentate motifs are coordinated to one metal center to form the proposed structures illustrated in FIG. 5. These results also suggest that the bipodal ligands can coordinate with their different coordination moieties in bidentate or tridentate fashion with the imine triazole unit excluding or including the pyridine one. The competition of two different ligand conformations might be a reasonable explanation for these observations. By MS, we can clearly distinguish masses that can be associated to three different proposed structures in solutions and assumed to be formed from the same ligand and Fe(II) under one reaction condition.

### REFERENCES

A number of publications are cited above in order to more fully describe and disclose the invention and the state of the art to which the invention pertains. Full citations for these references are provided below. The entirety of each of these references is incorporated herein.

CN 102702304

STEINER, S. et al., 2019, “Organic synthesis in a modular robotic system driven by a chemical programming language”, Science, Vol. 363, pp 1-8.

1. A fluid handling device comprising:
(a) a fluid directing manifold comprising an array of interconnected multi-directional valves, and a plurality of ports in fluid connection with the array; and
(b) a controller to set the position of the multi-directional valves, wherein the manifold is configured to provide at least two independent flow paths between a pair of ports within the manifold.

2. The fluid handling device of claim 1, wherein at least one of the multi-directional valves in the manifold is connected to at least three other multi-directional valves in the manifold.

3. The fluid handling device of claim 1, wherein the manifold comprises at least four multi-directional valves.

4. The fluid handling device of claim 1, wherein the manifold has a partial mesh topology.

5. The fluid handling device of claim 1, wherein the manifold has a non-hierarchical topology.

6. The fluid handling device of claim 1, wherein each/at least one multi-directional valves are 6-way valves.

7. The fluid handling device of claim 1, wherein the flow path through the manifold for a given fluid movement is not predetermined.

8. A method for controlling the fluid handling device of claim 1, the method comprising:
(i) identifying the shortest flow path through the manifold; and
(ii) operating the multi-directional valves to select the shortest flow path.

9. The method of claim 8, wherein, if there is more than one shortest flow path through the manifold, the method comprises randomly selecting one of the shortest flow paths.

10. The method of claim 8, wherein the method comprises:
(i) assessing a state of each valve and interconnection in the manifold, wherein a state can be clean or dirty;
(ii) identifying a flow path through the manifold using only clean valves and interconnections.

11. The method of claim 8, wherein the method comprises:
(i) assessing a state of each valve and interconnection in the manifold, wherein a state can be operational or failed; and
(ii) identifying a flow path through the manifold using only operational valves and interconnections.

12. The method of claim 10, wherein the method comprises assessing the state of each valve and interconnection in real-time.

13. The method of claim 8, wherein the method comprises:
(i) providing a graph representation of the manifold, optionally wherein in the graph representation nodes represent valves and edges represent interconnections.

14. The method of claim 8, wherein the method comprises:
(i) simultaneously identifying more than one flow path through the manifold; and
(ii) operating the multi-directional valves to correspond to each flow path,
to permit simultaneous movement of more than one fluid through the manifold.

15. The method of claim 14, wherein the more than one flow path comprise:
(i) one flow path form movement of a reagent fluid through the manifold; and
(ii) one flow path for movement of a cleaning fluid through the manifold.

16. The method of a claim 8, the method comprising:
(i) operating pumps to provide movement of a fluid through the flow path.

17. A method for controlling the fluid handling device of claim 1, the method comprising:
(i) identifying multiple independent flow paths through the manifold; and
(ii) operating the multi-directional valves to select the multiple independent flow paths.

18. The fluid handling device of claim 1, which is a component of an automated chemical syntheses platform.
